(19) United States
(12) Patent Application Publication
(10) Pub. No.: US 2022/0126363 A1
(43) Pub. Date: Apr. 28, 2022

(54) ALLOYS WITH A LOW DENSITY OF PRECIPITATES FOR USE IN APPLICATIONS THAT INCLUDE REMELTING PROCESSES, AND PREPARATION PROCESS THEREOF

(71) Applicant: EQUISPHERES INC.,, Ottawa (CA)

(72) Inventors: Willard Mark Truman GALLERNEAULT, Glenburnie (CA); Kamran Azari DORCHEH, Kanata (CA); Shengze YIN, Stittsville (CA); Martin John CONLON, Ottawa (CA)

(21) Appl. No.: 17/427,715

(22) PCT Filed: Feb. 7, 2020
(86) PCT No.: PCT/CA2020/050170

§ 371 Date: Aug. 2, 2021

Related U.S. Application Data
(60) Provisional application No. 62/802,498, filed on Feb. 7, 2019.

(51) Int. Cl. B22F 9/08; B33Y 40/10; C22C 1/02; C22C 21/06; C22F 1/047

(52) U.S. Cl. CPC B22F 9/082; B33Y 40/10; B22F 2301/052; C22C 21/06; C22F 1/047; C22C 1/026

(57) ABSTRACT

A method for producing a metal-based powder that is used in metal additive manufacturing, the method comprising: melting alloy metal precursors at a temperature above a liquidus temperature thereof until all alloy metal precursors are in liquid state, to produce a molten alloy; casting the molten alloy by transferring the molten alloy into a caster; cooling the molten alloy to a temperature of at least below the solidus temperature, at a cooling rate above about 50° C./s, to produce a cast alloy with a low density of precipitates; remelting the cast alloy with a low density of precipitates to produce a melted alloy; and forming the metal-based powder from the remelted alloy.

### RELATED APPLICATION

This application claims priority under applicable laws to United States provisional application No. 62/802,498 filed on Feb. 7, 2019, the content of which is incorporated herein by reference in its entirety for all purposes.

### TECHNICAL FIELD

The technical field generally relates to cast alloys, particularly to cast alloys with a low density of precipitates, a process for producing such cast alloys with a low density of precipitates, and their use in applications that include remelting or sintering.

### BACKGROUND

One drawback associated with the production of alloy ingots is the formation of precipitates during casting or re-solidification. As an example, Al₃(Sc, Zr) stable precipitates (or intermetallic particles) are formed under normal cooling conditions of quaternary aluminum-magnesium-scandium-zirconium alloy ingots. These precipitates can cause complications during further treatments and transformations, particularly if the ingot needs to be remelted or sintered. It is thus desirable to minimize a size of the precipitates so that such precipitates can be uniformly distributed during the solidification process, thereby being substantially unaffected by sedimentation or flotation forces associated with their different density (mass-based) from the still liquid phase. As an example of further transformation, a cast alloy ingot can be remelted and subsequently atomized and solidified to form a metal-based powder. The metal-based powder can be used in metal additive manufacturing processes. In such an example, the physical or mechanical properties of the metal-based powder can have a significant impact on the metal additive manufacturing process as well as on the final metal product. The presence of precipitates in the alloy feedstock is thus associated to various challenges.

In one example, the precipitates can be unevenly dispersed in the alloy ingot, thereby creating inhomogeous spatial distributions of chemical species or compositional variations in the ingot from one position to another (e.g. radial variation or axial variation or any combination thereof). For example, the alloy ingot can demonstrate anisotropic behaviors, or can be directionally dependent or can have different properties in different directions. In another example, the precipitates can be unevenly dispersed in the alloy ingot leading to geometrical variations in chemical composition inconsistencies between aliquots from a same ingots batch.

In another example, the precipitates can include alloying elements (e.g. Al, Sc and/or Zr as above mentioned) and if the precipitates are not fully dissolved or melted during the remelting step, a lower concentration of these alloying elements will be available in the melt. In other words, the principle α-phase of the alloy may tend to have regions rich in the alloying element which has not precipitated (e.g. magnesium) or regions depleted of the alloying elements which have precipitated (e.g. aluminum, scandium and/or zirconium).

In another example, variation in the composition of the feedstock can cause variability in the composition and/or inhomogeneous material properties of a subsequent transformation product (for example, a metal powder such as those used in metal additive manufacturing processes). For instance, using a powder feedstock having anisotropic or inhomogeneous material properties in the additive manufacture of a metallic component may lead to undesired mechanical properties, nonuniform layers or in an increased number of defects.

As a further example, the presence of solid precipitates in a molten alloy can also create issues including, but not limited to, blocking filters used during the remelting step. This blocking can lead to a melt having a lower concentration of at least one of the alloying elements and can affect any subsequent transformation process or treatment.

Accordingly, many technical challenges still exist and there is a need for cast alloys and processes for fabrication thereof, that overcome one or more of the drawbacks of conventional cast alloys and their preparation processes.

### SUMMARY

According to one aspect, the present technology relates to a method for producing a metal-based powder that is used in metal additive manufacturing, the method comprising:
melting alloy metal precursors at a temperature above a liquidus temperature thereof until all alloy metal precursors are in liquid state, to produce a molten alloy;
casting the molten alloy by transferring the molten alloy into a caster;
cooling the molten alloy to a temperature of at least the solidus temperature, at a cooling rate above about 50° C./s, to produce a cast alloy with a low density of precipitates;
remelting the cast alloy with a low density of precipitates to produce a melted alloy; and
forming the metal-based powder from the remelted alloy.

In one embodiment, the temperature at which is cooled the molten alloy is at least about 70° C. below the solidus temperature to inhibit a growth rate of precipitates.

In another embodiment, the temperature at which is cooled the molten alloy is of about 50% of the solidus temperature to inhibit a growth rate of precipitates.

In another embodiment, the method further comprises a homogenization step of the cast alloy with a low density of precipitates to further decrease a density of the precipitates in the cast alloy. In one example, the homogenization step includes heat treating the cast alloy with a low density of precipitates to a temperature T during a period of time.

In another embodiment, the cooling rate is in the range of from about 50° C./s to about 110° C./s, limits included.

In another embodiment, the casting of the molten alloy is performed by direct chill casting, book mold casting or twin-roll casting.

In another embodiment, the remelting is performed at a heating rate of less than about 10° C./s.

In another embodiment, the remelting is performed at a heating rate in the range of from about 0.01° C./s to about 10° C./s, limits included.

In another embodiment, forming the metal-based powder from the remelted alloy is performed by atomization.

According to another aspect, the present technology relates to a process for producing a cast alloy with a low density of precipitates tailored to additive manufacturing applications, the process comprising:
melting alloy metal precursors at a temperature above a liquidus temperature thereof until all alloy metal precursors are in liquid state, to produce a molten alloy;
casting the molten alloy by transferring the molten alloy into a caster;
cooling the molten alloy to a temperature of at least the solidus temperature, at a cooling rate above about 50° C./s, to produce the cast alloy with a low density of precipitates.

In one embodiment, the temperature at which is cooled the molten alloy is at least about 70° C. below the solidus temperature to inhibit a growth rate of precipitates.

In another embodiment, the temperature at which is cooled the molten alloy is of about 50% of the solidus temperature to inhibit a growth rate of precipitates.

In another embodiment, the process further comprises a homogenization step of the cast alloy with a low density of precipitates to further decrease a density of the precipitates in the cast alloy. In one example, the homogenization step includes heat treating the cast alloy with a low density of precipitates to a temperature T during a period of time.

In another embodiment, the cooling rate is in the range of from about 50° C./s to about 110° C./s, limits included.

In another embodiment, the casting of the molten alloy is performed by direct chill casting, book mold casting or twin-roll casting.

According to another aspect, the present technology relates to a process for producing a remelted alloy with homogeneously dispersed precipitates tailored to additive manufacturing applications, the process comprising:
melting alloy metal precursors at a temperature above a liquidus temperature thereof until all alloy metal precursors are in liquid state, to produce a molten alloy;
casting the molten alloy by transferring the molten alloy into a caster;
cooling the molten alloy to a temperature of at least the solidus temperature, at a cooling rate above about 50° C./s, to produce a cast alloy with a low density of precipitates; and
remelting the cast alloy with a low density of precipitates to produce a remelted alloy.

In one embodiment, the temperature at which is cooled the molten alloy is at least about 70° C. below the solidus temperature to inhibit a growth rate of precipitates.

In another embodiment, the temperature at which is cooled the molten alloy is of about 50% of the solidus temperature to inhibit a growth rate of precipitates.

In another embodiment, the process further comprises a homogenization step of the cast alloy with a low density of precipitates to further decrease a density of the precipitates in the cast alloy. In one example, the homogenization step includes heat treating the cast alloy with a low density of precipitates to a temperature T during a period of time.

In another embodiment, the cooling rate is in the range of from about 50° C./s to about 110° C./s, limits included.

In another embodiment, the casting of the molten alloy is performed by direct chill casting, book mold casting or twin-roll casting.

In another embodiment, the remelting is performed at a heating rate of less than about 10° C./s.

In another embodiment, the remelting is performed at a heating rate in the range of from about 0.01° C./s to about 10° C./s, limits included.

According to another aspect, the present technology relates to a cast alloy with a low density of precipitates produced by the process as defined herein.

In one embodiment, the cast alloy comprises at least one of aluminum (Al) and magnesium (Mg).

In another embodiment, the cast alloy further comprises scandium (Sc).

In another embodiment, the cast alloy further comprises zirconium (Zr).

In another embodiment, the cast alloy is a ternary alloy or a quaternary alloy.

In another embodiment, the precipitates contained in the cast alloy comprise Al₃(Sc, Zr) of formula Al₃(Sc₁₋ₓ, Zrₓ), where x is 0≤x≤1.0.

In another embodiment, the average size of the precipitates is less than about 50 μm. In one example, the average size of the precipitates is less than about 10 μm. In another example, the average size of the precipitates is less than about 5 μm.

In another embodiment, the precipitates are substantially homogeneously dispersed in the cast alloy.

In another embodiment, a chemical composition of the cast alloy is substantially uniform from one radial position to another radial position, and/or from one axial position to another axial position.

In another embodiment, a chemical composition of the cast alloy is uniform from one batch to another.

According to another aspect, the present technology relates to a remelted alloy with homogeneously dispersed precipitates produced by the process as defined herein.

In one embodiment, the remelted alloy comprises at least one of aluminum (Al) and magnesium (Mg).

In another embodiment, the remelted alloy further comprises scandium (Sc).

In another embodiment, the remelted alloy further comprises zirconium (Zr).

In another embodiment, the remelted alloy is a ternary alloy or a quaternary alloy.

In another embodiment, a chemical composition of the remelted alloy is substantially uniform from one radial position to another radial position, and/or from one axial position to another axial position.

In another embodiment, a chemical composition of the remelted alloy is uniform from one batch to another.

According to another aspect, the present technology relates to a use of the cast alloy as defined herein in an application that includes a subsequent remelting process.

According to another aspect, the present technology relates to a use of the remelted alloy as defined herein as a metal alloy feedstock in the production of a metal-based powder tailored for subsequent metal additive manufacturing.

According to a yet another aspect, the present technology relates to a process for producing a cast alloy with a low density of precipitates, the process comprising the steps of:
melting the alloy metal precursors at a temperature above the liquidus temperature until all alloy metal precursors are liquid, to produce a molten alloy;
casting the molten alloy by transferring the molten alloy into a caster;
cooling the molten alloy to a temperature of at least below the solidus temperature, at a cooling rate above 50° C./s to produce a cast alloy with a low density of precipitates; and
remelting the cast alloy with a low density of precipitates.

In one embodiment, the molten alloy is cooled to a temperature of at least about 70° C. below the solidus temperature to inhibit a growth of the precipitates.

In another embodiment, the casting of the molten alloy is performed by direct chill casting, book mold casting or twin-roll casting.

According to a further aspect, the present technology relates to a cast alloy with a low density of precipitates produced by the process as described herein.

In one embodiment, said alloy comprises at least one of aluminum (Al) and magnesium (Mg).

In another embodiment, said alloy further comprises scandium (Sc) and/or zirconium (Zr).

In another embodiment, the precipitates comprise Al₃(Sc, Zr) of formula Al₃(Sc₁₋ₓZrₓ), where x is 0≤x≤1.0.

In another embodiment, the average size of the precipitates is less than about 50 μm.

In another embodiment, the composition of the cast alloy is substantially uniform in chemical composition from one position to another (e.g., radial and axial).

In another embodiment, the chemical composition of the cast alloy is uniform from one batch to another.

In another embodiment, the cast alloy is used in an application that includes a subsequent remelting process.

In another embodiment, the cast alloy is used as a metal alloy feedstock in the production of a metal alloy powder used in additive manufacturing.

### BRIEF DESCRIPTION OF THE DRAWINGS

FIG. 1 is an optical micrograph of an upper surface of a 13 cm diameter cylindrical cast Al—Mg—Sc—Zr alloy ingot with a magnification of 50×, as described in Example 1 (a). Scale bar represents 200 μm.

FIG. 2 is an optical micrograph of a lower surface of the 13 cm diameter cylindrical cast Al—Mg—Sc—Zr alloy ingot with a magnification of 50×, as described in Example 1 (a). Scale bar represents 200 μm.

FIG. 3 is an optical micrograph of an upper surface of a 5 cm diameter cylindrical cast Al—Mg—Sc—Zr alloy ingot with a magnification of 50×, as described in Example 1 (b). Scale bar represents 200 μm.

FIG. 4 is an optical micrograph of a lower surface of the 5 cm diameter cylindrical cast Al—Mg—Sc—Zr alloy ingot with a magnification of 50×, as described in Example 1 (b). Scale bar represents 200 μm.

FIG. 5 is an optical micrograph presenting the microstructure of an upper surface of a 16 mm thick cast Al—Mg—Sc—Zr alloy ingot with a magnification of 50×, as described in Example 1 (c). Scale bar represents 200 μm.

FIG. 6 is an optical micrograph showing the microstructure of a lower surface of the 16 mm thick Al—Mg—Sc—Zr cast alloy ingot with a magnification of 50×, as described in Example 1 (c). Scale bar represents 200 μm.

FIG. 7 is an optical micrograph showing the microstructure of a lower surface of a 16 mm thick Al—Mg—Sc—Zr cast alloy ingot with a magnification of 500×, as described in Example 1 (c). Scale bar represents 20 μm.

FIG. 8 is an optical micrograph showing the microstructure of an upper surface of an 8 mm thick Al—Mg—Sc—Zr cast alloy ingot with a magnification of 50×. Scale bar represents 200 μm.

FIG. 9 is an optical micrograph showing the microstructure of a lower surface of the 8 mm thick Al—Mg—Sc—Zr cast alloy ingot with a magnification of 50×. Scale bar represents 200 μm.

FIG. 10 is a multi-component phase diagram of an Al—Mg—Sc—Zr quaternary alloy, as described in Example 3.

FIG. 11 displays a zoomed in section showing the portion between 750° C. and 600° C. of the phase diagram presented in FIG. 10, as described in Example 3.

FIG. 12 is a precipitation diagram obtained at a temperature of 800° C. for 20 μm diameter Al₃Sc intermetallic precipitates, as described in Example 4.

FIG. 13 is a precipitation diagram obtained at a temperature of 900° C. for 20 μm diameter Al₃Sc intermetallic precipitates, as described in Example 4.

FIG. 14 is a precipitation diagram obtained at a temperature of 1000° C. for 20 μm diameter Al₃Sc intermetallic precipitates, as described in Example 4.

### DETAILED DESCRIPTION

The following detailed description and examples are illustrative and should not be interpreted as further limiting the scope of the invention. On the contrary, it is intended to cover all alternatives, modifications and equivalents as may be included as defined by the present description. The objects, advantages and other features of the present techniques will become more apparent and be better understood upon reading of the following non-restrictive description, given with reference to the accompanying drawings.

All technical and scientific terms and expressions used herein have the same definitions as those commonly understood by the person skilled in the art when relating to the present technology. The definition of some terms and expressions used herein is nevertheless provided below for clarity purposes.

When the term “approximately” or its equivalent term “about” are used herein, it means approximately or in the region of, and around. When the terms “approximately” or “about” are used in relation to a numerical value, it modifies it; for example, by a variation of 10% above and below its nominal value. This term may also take into account rounding of a number or the probability of random errors in experimental measurements; for instance, due to equipment limitations.

When a range of values is mentioned herein, the lower and upper limits of the range are, unless otherwise indicated, always included in the definition. When a range of values is mentioned in the present application, then all intermediate ranges and subranges, as well as individual values included in the ranges, are intended to be included.

It is worth mentioning that throughout the following description when the article “a” is used to introduce an element it does not have the meaning of “only one” it rather means of “one or more”. It is to be understood that where the specification states that a step, component, feature, or characteristic “may”, “might”, “can” or “could” be included, that particular component, feature or characteristic is not required to be included.

Various techniques described herein are related to the production of cast alloys with a low density of precipitates compared to cast alloys obtained according to conventional methods which use cooling rates in the range of in the range of from about 10⁻³° C./s to about 1° C./s.

For more clarity, the expression “count density” or its equivalent expression “number density” as used herein refer to a volumetric density or a number of specified species (e.g., precipitates or particules) per volume unit. Alternatively, the expression “count density” or its equivalent expression “number density” as used herein refer to a surface density or a number of specified species per surface area unit.

The expression “low density of precipitates” as used herein refers to at least one of a decrease in precipitate size, a reduction in count density of precipitates and an increase in dispersity of precipitates compared to cast alloys obtained according to conventional methods which use cooling rates in the range of in the range of from about 1° C./s to about 1° C./s.

For more clarity, the expression “a decrease in precipitate size” as used herein refers to a substantially reduced average precipitate diameter or a decrease in average Feret diameter for a non-spherical precipitate or a decrease in the average radius and/or half-length for a needlelike precipitates compared to cast alloys obtained according to conventional methods which use cooling rates in the range of from about 10⁻³° C./s to about 1° C./s.

The expression “a reduction in count density of precipitates” as used herein refers to a reduced count of precipitates per surface or volume unit or the number of precipitates within a given surface or volume compared to cast alloys obtained according to conventional methods which use cooling rates in the range of from about 10⁻³° C./s to about 1° C./s.

As used herein, the expression “an increase in dispersity of precipitates” refers to an increase in the average distance between precipitates compared to cast alloys obtained according to conventional methods which use cooling rates in the range of from about 10⁻³° C./s to about 1° C./s. For instance, when the average distance between precipitates or number density is uniform at different locations of a cast alloy, the precipitates can be considered as well dispersed. As such, the dispersity or dispersion can be defined by the average distance between precipitates.

Process and Method Implementations

According to one aspect, the present techniques relate to a cooling rate dependent process for producing a cast alloy with a low density of precipitates. Meaning that the amount of precipitates, such as Al₃(Sc₁₋ₓZrₓ) wherein x is 0≤x≤1.0 precipitates present in the cast alloy after casting or re-solidification, decreases with increasing re-solidification or cooling rates.

The process for producing the cast alloy with a low density of precipitates includes melting alloy metal precursors to a temperature above the liquidus temperature until all the alloy metal precursors are in their liquid state (i.e., the alloy is homogeneous and a liquid at equilibrium), thereby producing a molten alloy.

The process additionally includes casting the molten alloy by transferring the molten alloy into a caster. Optionally, the casting can be carried out by pouring the molten alloy into the caster.

The process also includes cooling the molten alloy to below the solidus temperature at a cooling rate above about 50° C./s to produce a cast alloy with a low density of precipitates.

In some embodiments, the casting and cooling steps may be performed sequentially, simultaneously, or partially overlapping in time with each other. For instance, the casting and cooling steps may be performed simultaneously or they may be partially overlapping in time with each other. For example, the cooling step may be carried out immediately following the beginning of the casting step.

In some embodiments, the cooling rate may be selected based on the extension of the liquidus and solidus lines on the phase diagram and on the alloy composition. Under such conditions the precipitation in said alloy is reduced through kinetic inhibition of the precipitation process, to produce a cast alloy with a low density of precipitates. In some embodiments, the cooling step of the process as described herein may be carried out at a cooling rate in the range of from about 50° C./s to about 110° C./s. For example, the cooling step may be carried out at a cooling rate in the range of from about 50° C./s to about 100° C./s, or from about 50° C./s to about 90° C./s, limits included. For sake of comparison, standard cooling rates for conventional casting in the industry are in the range of from about 10⁻³° C./s to about 1° C./s. For instance, an average cooling rate in the range of from about 0.1° C./s to about 1° C./s is typical for a conventional direct chill casting method.

It should be further noted that any compatible cooling methods are contemplated herein to operate the cooling of the molten alloy. For instance, the cooling method can be selected for its ability to provide a rapid cooling as defined herein. In some embodiments, the cooling method can include using a quenchant or a cooling medium. For instance, the cooling method can include but is not limited to refrigerant cooling, liquid cooling, water cooling, forced air cooling, air-water cooling and other similar cooling methods. In some embodiments, the cooling method can be selected for its compatibility (or ability not to react) with the molten alloy (i.e., for its inertness). For example, the molten alloy can be solidified by a non-contact cooling method, e.g. through a mold. In one example, at least one external side of the mold can be cooled by circulating a cooling medium without direct contact between the cooling medium and the molten alloy. In another example, the non-contact cooling medium can circulate within an external side and an internal side of the mold. In some embodiments, a secondary cooling method can be used to further cool the alloy. For example, the secondary cooling method can be used once at least an outside layer of the alloy is solidified. Optionally, the secondary cooling method can be a direct cooling method such as direct chill casting.

It should further be noted that any compatible measuring method is contemplated for measuring the cooling rate during cooling. In some embodiments, the cooling rate can be an average cooling rate and can be estimated by measuring heat transfer across the mold, for example, by measuring heat transfer from the alloy to the cooling system (for example, a water-cooling system). For instance, the average cooling rate can be estimated by measuring heat transfer from the alloy to an inlet or an outlet of the cooling system. In some embodiments, the cooling rate can be obtained by using a thermal analyzer or a calorimeter. For instance, the thermal analyzer or calorimeter can be selected from a thermocouple, a differential scanning calorimeter, a simultaneous thermal analyzer and other suitable thermal analyzers and calorimeters. In other embodiments, the cooling rate can be obtained by recording the temperature of the alloy at a predetermined time to obtain a temperature-time measurement point during the cooling step. For example, the cooling rate can be derived from a cooling curve obtained using several temperature-time measurement points. The temperature sequence can be monitored using a data acquisition system during the cooling step. The temperature-time measurement points can be recorded at one or more location(s) of the cast alloy. For example, the temperature-time measurement points can be recorded at an axial center of the alloy, or at one or more location(s) at a periphery of the alloy, or at the axial center of the alloy and at one or more location(s) at the periphery of the alloy. It is to be understood that, the observed cooling curve and/or cooling rates can also be analysed according to various cooling models, for instance, any compatible cooling model or mathematical cooling model is contemplated.

It is to be understood that, at a temperature above the liquidus temperature, the alloy is homogeneous and liquid at equilibrium. It is also to be understood that, at a temperature below the solidus temperature, the alloy is completely solid at equilibrium. As such, at a temperature below the liquidus temperature, solidification points can start to form and grow in the molten alloy. In some embodiments, at a temperature below the liquidus temperature, the precipitates can form and grow in accordance with the nature of the alloy metal precursors. It is to be understood that, a bulk solidification of the principle α-phase begins at the solidus temperature and the growth rate starts to decrease. For instance, the temperature at which the growth of the precipitates is stopped, depends on the atomic size of the alloying elements and on the matrix. Indeed, the growth below solidus is diffusion controlled, and the diffusion at a given temperature is mainly controlled by atomic sizes. Therefore, the solidus temperature mainly depends on composition and is alloy dependent.

For example, for a given alloy composition, at least one of the average size of the precipitates (or particles), their count density and dispersity in the cast alloy can be directly linked to the cooling rate used to cool the molten alloy from the liquidus temperature to at least the solidus temperature. Meaning that at least one of the average size of the precipitates (or particles), their count density and dispersity in the cast alloy or the formation of precipitates can be cooling rate dependent.

In some embodiments, to reduce or inhibit the formation (sedimentation or flotation) of precipitates and to reduce the growth rate of precipitates (i.e. increase in size of precipitates), the cooling of the molten alloy can be performed at a temperature of about 50% of the solidus temperature. For example, if the solidus temperature of a specific alloy is about 650° C., then the molten alloy can be cooled to a temperature of about 325° C. at the cooling rate as defined herein. For example, the molten alloy can cooled down at the cooling rate as defined herein from a temperature between below the liquidus temperature and about 70° C. under the solidus temperature, to inhibit the growth rate of precipitates.

It should further be noted that any suitable casting methods can be selected provided that the selected casting method is compatible with the cooling rates and casting conditions of the process described herein. Non-limiting examples of conventional casting methods include direct chill casting, book mold casting and twin-roll casting. Optionally, the casting method can be direct chill. Further optionally, the casting method can be book mold casting.

Implementations of the process as defined herein enable the molten alloy to quickly solidify due to a high cooling rate, while formation of precipitates is substantially suppressed or inhibited, and/or the particle size of the precipitates is significantly reduced, and/or the dispersion of the precipitates in the cast alloy is substantially increased, and/or the count density of the precipitates is significantly reduced—meaning that, by using the process implementations as defined herein, the precipitate density may thus be reduced in comparison to that of cast alloys produced by conventional processes.

In some embodiments, the process optionally further includes a homogenization step. For instance, the homogenization step can include heat treating or ageing (for example, controlled ageing) the cast alloy with a low density of precipitates, as described above, to a temperature T until a total energy is sufficient to at least partially dissolve the precipitates and produce cast alloys with an even lower density of precipitates than without homogenization. For example, the precipitates can be dissolved in solid state without going above the solidus temperature and without melting the alloy completely. The temperature T in the homogenization step depends on the composition of the alloy. In some examples, for a specific alloy, the temperature T can be above 400° C. For example, the temperature T can be above 450° C., or above 500° C., or above 550° C., or above 600° C., or above 650° C. In some examples, for a specific alloy, the temperature T can be in the range of from about 450° C. to about 650° C. For instance, for a specific alloy the temperature T can be above 650° C. for a period of time in excess of 24 hours.

The cast alloy with a low density of precipitates produced according to the preparation process as defined herein can be tailored for use in an application including a subsequent remelting process. In one variant of interest, the cast alloy with a low density of precipitates produced according to the preparation process as defined herein is tailored to further additive manufacturing applications and advantageously used to form a metal-based powder.

According to another aspect, there is provided a method for producing a remelted alloy with homogeneously dispersed precipitates tailored to additive manufacturing applications, the method including remelting a cast alloy with a low density of precipitates as described herein to produce a remelted alloy. In some implementations, the remelting rate of the remelting step can be limited by the type of melting furnace that is used. It should be noted that any compatible type of melting furnace is contemplated. For instance, starting from a substantially solid cast alloy and using resistance or induction heating, the remelting rate can be less than about 10° C./s. Optionally, the remelting rate can be in the range of from about 0.01° C./s to about 10° C./s.

In some embodiments, the precipitates can be evenly dispersed in the cast alloy, thereby creating homogenous spatial distributions of chemical species in the remelted alloy from one position to another (e.g. radial variation or axial variation or any combination thereof). In another example, the precipitates can be evenly dispersed in the cast alloy ingot leading substantially comparable chemical composition between aliquots from a same remelted alloy batch.

The remelted alloy with homogeneously dispersed precipitates is tailored to be used as a metal alloy feedstock in the production of a metal-based powder tailored for subsequent metal additive manufacturing. As described above, the metal-based powder is an important part of metal additive manufacturing, because their quality can influence the stability of production process as well as the quality of final product.

According to another aspect, there is provided a method for producing a metal-based powder that is used in metal additive manufacturing, the method including forming the cast alloy with a low density of precipitates according to the techniques described herein, remelting the cast allow with a low density of precipitates to form a remelted alloy according to the techniques described herein, and forming the metal-based powder from a remelted alloy according to the techniques described herein and other techniques available in the art as readily understood by one skilled in the art.

In some implementations, the formation of the metal-based powder from the remelted alloy can be performed according to methods available in the art. For example, the formation of the metal-based powder from the remelted alloy can be performed by a conventional physical—chemical method or by a conventional mechanical method. In on variant of interest, the formation of the metal-based powder from the remelted alloy is performed by a mechanical method, including but not limited to, various types of milling processes and jet dispersion melts by high pressure of gas or liquid (atomization).

Cast Alloy Implementations

According to another aspect, there is provided herein a cast alloy with a low density of precipitates that is produced according to a preparation process as defined herein.

In some embodiments, a size of the precipitates in the cast alloy can be cooling rate dependent. For instance, the average size of the precipitates in the cast alloy obtained using the process as described herein can be less than about 50 μm. For example, the average size of the precipitates in the cast alloy obtained using the process as described herein can be less than about 40 μm, or less than about 30 μm, or less than about 20 μm, or less than about 10 μm. For instance, the average size of the precipitates in the cast alloy obtained using the process as described herein can be in the range of from about 5 μm to about 50 μm, or from about 5 μm to about 40 μm, or from about 5 μm to about 30 μm, or from about 5 μm to about 20 μm, from about 5 μm to about 10 μm, or from about 10 μm to about 30 μm, or from about 15 μm to about 30 μm, or from about 20 μm to about 30 μm, limits included.

For comparison purposes, the average size of precipitates in a cast alloy obtained with a conventional preparation process and at a typical cooling rate is in the range of from about 50 μm to about 200 μm.

In some embodiments, the count density and the dispersity of precipitates can also be cooling rate dependent. In some example, the dispersity of precipitates in the cast alloy obtained using the process as described herein can be in the range of from about 20 precipitates per mm² to about 200 precipitates per mm². However, it is to be understood that the count density and the dispersity of precipitates can also depend on the definition and/or magnification of the optical micrograph as higher magnification can be required to count smaller particules. In one example, at a magnification of 50× the dispersity of precipitates in the cast alloy obtained using the process as described herein can be less than about 30 precipitates per mm². For example, at a magnification of 50× the dispersity of precipitates in the cast alloy obtained using the process as described herein can be in the range of from about 20 to about 30 precipitates per mm², limits included. In another example, at a magnification of 500× the dispersity of precipitates in the cast alloy obtained using the process as described herein can be up to about 600 precipitates per mm². Therefore, the comparison between the dispersity of precipitates obtained with different cooling rate must be performed using images obtained with the same magnification and using the same boundary conditions, for instance, by counting precipitates having a specific size or by excluding events of lower and/or greater magnitude.

It is to be noted that, the size of the precipitates in the cast alloy obtained using the process as described herein can be decreased compared to the size of the precipitates in a cast alloy produced via a conventional preparation process, no matter the magnification used.

In some embodiments, the cast alloy as described herein can include at least one of aluminum and magnesium. For instance, the cast alloy can include aluminum and magnesium and can be an Al—Mg based alloy. For instance, the cast alloy can include at least about 0.5 wt. % of magnesium and at least about 93.8 wt. % of aluminum.

In some embodiments, the cast alloy can consist of only two constituents. Alternatively, the cast alloy can include two or more constituents. For example, the cast alloy can be a binary, a ternary or a quaternary alloy.

In some embodiments, at least one additional alloying element can be present in the cast alloy to improve physical and/or mechanical properties thereof. For instance, the at least one additional alloying element can be a transition metal. For instance, the additional alloying element can be scandium, zirconium, another similar transition metal or a combination thereof. Optionally, the cast alloy can include aluminum, magnesium, scandium and zirconium. For instance, the cast alloy can comprise from about 0.001 wt. % to about 0.4 wt. % of zirconium, from about 0.2 wt. % to about 0.8 wt. % of scandium, from about 0.5 wt. % to about 5.0 wt. % of magnesium and from about 93.8 wt. % to about 99.3 wt. % of aluminum.

In some embodiments, the cast alloy can include precipitates including Al₃(Sc, Zr) of formula Al₃(Sc₁₋ₓ, Zrₓ), wherein x is 0≤x≤1.0.

In some embodiments, the cast alloy prepared by the process as described herein can be substantially free of precipitates. In some embodiments, the cast alloy prepared by the process as described herein can contain precipitates which are substantially reduced in size relative to the size of precipitates prepared with conventional casting methods. For example, in some embodiments, the size of precipitates can be less than about 50 μm. In some embodiments, the cast alloy prepared by the process as described herein can be characterized by a significantly reduced count density of precipitates compared to that of cast alloys prepared with conventional casting methods. In some embodiments, the cast alloy prepared by the process as described herein can be characterized by both a reduction in the size and count density of precipitates compared to that of cast alloys prepared with conventional casting methods.

In some embodiments, the precipitates can be substantially homogeneously dispersed. More particularly, the cast alloy can be substantially uniform in composition from one location to another (e.g., radial and axial). For instance, the radial and/or axial composition can be substantially uniform within a 10 mm step and can reach the nominal composition. Meaning that the average global composition of the cast alloy can remain constant within a 10 mm step. For example, the radial and axial composition may be determined by at least one of spark optical emission spectroscopy, spark atomic emission spectroscopy, and energy-dispersive X-ray spectroscopy used in conjunction with scanning electron microscopy. In other embodiments, the cast alloy can demonstrate isotropic behavior (i.e., uniformity in all orientations). In some embodiments, the chemical composition of the cast alloy may be substantially uniform from one batch to another.

In some embodiments, the size, the count density and the dispersity of precipitates can be obtained from an optical micrograph. For example, the size, the count density and the dispersity of precipitates may be measured manually or automatically. In one example, the size, the count density and the dispersity of precipitates can be measured by manual precipitate counting and/or by manually measuring the size of the precipitates and distance between precipitate. In one example, the size, the count density and the dispersity of precipitates can be measured by automatically using an image analysis software (or an image-processing program) such as Fiji™ or ImageJ™.

Use Implementations

According to another aspect, there is provided a use of the cast alloy with a low density of precipitates as defined herein, in various applications including a subsequent remelting process. For example, cast alloy with a low density of precipitates as defined herein can be the subject of a subsequent rapid remelting process. It should however be noted that any compatible applications are contemplated.

In some embodiments, the cast alloy can be used in an application benefiting from a substantial absence of precipitates or a low density of precipitates. In some embodiments, the cast alloy can be used in an application requiring an alloy including precipitates of small size. In some embodiments, the cast alloy can be used in an application requiring an alloy being characterized by a substantially small count density of precipitates. In some embodiments, the cast alloy can be used in an application requiring an alloy including substantially homogeneously dispersed precipitates. In one variant of interest, the cast alloy with a low density of precipitates as defined herein can be used as a metal feedstock to prepare metal-based powders tailored to metal additive manufacturing. For example, the cast alloy with a low density of precipitates as defined herein can be used to form a remelted alloy via remelting and further form a metal-based powder tailored to metal additive manufacturing.

In some embodiments, the cast alloy with a low density of precipitates can be obtained by using embodiments of the process described herein. For instance, the cast alloy may contain precipitates which are substantially reduced in size. In some embodiments, the size or the average size of the precipitates may be less than about 50 μm, or less than about 10 μm, or less than about 5 μm. For instance, the size or the average size of the precipitates may be in the range of from about 0.5 μm to about 50 μm, limits included.

As stated above, the liquidus temperature is the temperature above which an alloy is completely liquid at equilibrium, and at constant pressure depends on the composition of the alloy. For instance, in some embodiments where the cast alloy is an Al—Mg based alloy, the liquidus temperature can be, for example, above about 620° C. For example, the liquidus temperature can be in the range of from about 620° C. to about 1 100° C., or from about 620° C. to about 1 000° C., or from about 620° C. to about 950° C., or from about 620° C. to about 900° C., or from about 660° C. to about 850° C., limits included.

As stated above, the solidus temperature is the temperature below which an alloy is completely solid at equilibrium and also depends on the composition of the alloy. For instance, in some embodiments where the cast alloy is an Al—Mg based alloy, the solidus temperature may be, for example, less than about 640° C. For example, the solidus temperature may be in the range of from about 640° C. to about 350° C., or from about 640° C. to about 400° C., or from about 640° C. to about 450° C., or from about 640° C. to about 500° C., limits included.

### EXAMPLES

The following non-limiting examples are illustrative embodiments and should not be construed as further limiting the scope of the present invention. These examples will be better understood in conjunction with the accompanying Figures.

### Example 1: Characterization of Cast Al—Mg—Sc—Zr Based Alloys

Examples 1 (c) and 1 (d) relate to the preparation of cast Al—Mg—Sc—Zr alloy ingots by the method as described in the present application, while Examples 1 (a) and 1 (b) are for comparison.
a) Effects of cooling rate on the presence, count density and size of precipitates in cylindrical cast Al—Mg—Sc—Zr alloy ingots (13 cm diameter) (comparative)

Cylindrical cast Al—Mg—Sc—Zr alloy ingots were prepared by solidifying a liquid metal alloy using a direct chill casting method.

To produce the cylindrical cast Al—Mg—Sc—Zr alloy ingot, the alloy metal precursors were weighted to obtain a desired stoichiometry and mixed. After mixing, the alloy metal precursors were then heated above the liquidus temperature until all of the alloy metal precursors were in their liquid state to thereby produce a molten alloy. The molten alloy was then poured into a mold (13 cm diameter) having a starter-dummy block at the bottom, which moved down semi-continuously withdrawing the cast ingot from the mold at the bottom over the course of the pour. The sides of the mold wall were water-cooled to allow the outer layer of metal alloy to solidify and achieve a cooling rate in the range of from about 0.1° C./s to about 1° C./s.

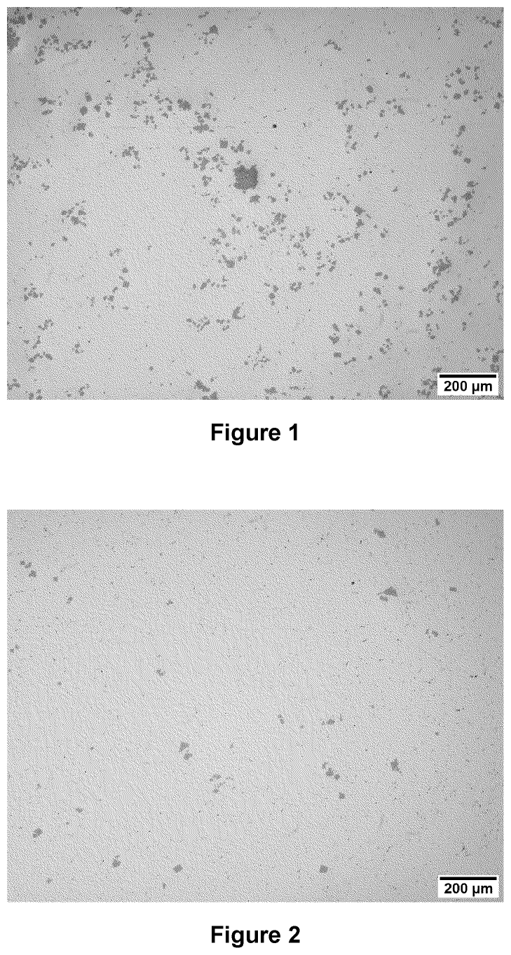

FIG. 1 is an optical micrograph taken at a magnification of 50× and obtained for an upper surface of a 13 cm diameter cylindrical cast Al—Mg—Sc—Zr alloy ingot prepared in Example 1 (a) (scale bar represents 200 μm).

FIG. 2 is an optical micrograph taken at a magnification of 50× and obtained for a lower surface of a 13 cm diameter cylindrical cast Al—Mg—Sc—Zr alloy ingot prepared in Example 1 (a) (scale bar represents 200 μm).

FIGS. 1 and 2 both show a nonuniform dispersion of Al₃(Sc₁₋ₓZrₓ) precipitates. As can be observed by comparing FIG. 1 and FIG. 2, the upper surface of the cylindrical Al—Mg—Sc—Zr cast alloy ingot includes a higher count density of Al₃(Sc₁₋ₓZrₓ) precipitates than the lower surface, the latter of which was cooled more rapidly. The average size of the Al₃(Sc₁₋ₓZrₓ) precipitates in FIG. 1 was also substantially greater than average size of the Al₃(Sc₁₋ₓZrₓ) precipitates in FIG. 2.
b) Effects of cooling rate on the presence, count density and size of precipitates in cylindrical cast Al—Mg—Sc—Zr based alloy ingots (5 cm diameter) (comparative)

Cylindrical cast Al—Mg—Sc—Zr alloy ingots were prepared by solidifying a liquid metal alloy by direct chill casting.

To produce a cylindrical cast Al—Mg—Sc—Zr alloy ingot, the alloy metal precursors were weighted to obtain a desired stoichiometry, mixed. After mixing, the alloy metal precursors were then heated to the liquidus temperature until all of the alloy metal precursors were in their liquid state to thereby produce a molten alloy. The molten alloy was then poured into a mold (5 cm diameter) having a starter-dummy block at the bottom, which moved down semi-continuously withdrawing the cast ingot from the mold at the bottom over the course of the pour. The external mold wall was water-cooled to allow the outer layer of metal alloy to solidify and achieve a cooling rate in the range of from about 10° C./s to about 50° C./s.

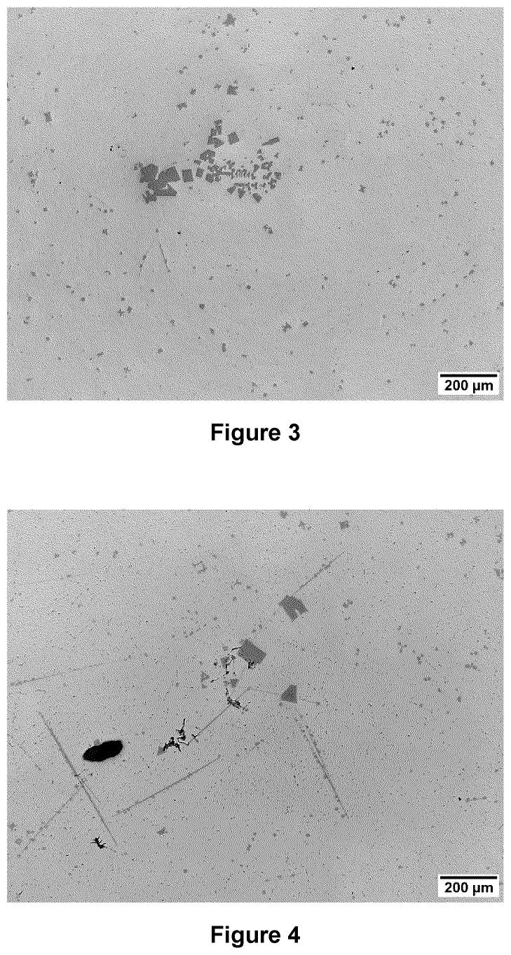

FIG. 3 is an optical micrograph taken at a magnification of 50× and obtained for an upper surface of a 5 cm diameter cylindrical cast Al—Mg—Sc—Zr alloy ingot prepared in Example 1 (b) (scale bar represents 200 μm).

FIG. 4 is an optical micrograph taken at a magnification of 50× and obtained for a lower surface of a 5 cm diameter cylindrical cast Al—Mg—Sc—Zr alloy ingot prepared in Example 1 (b) (scale bar represents 200 μm).

FIGS. 3 and 4 both show a nonuniform dispersion of the Al₃(Sc₁₋ₓZrₓ) precipitates. Similar to Example 1 (a), by comparing FIG. 3 and FIG. 4, it can be observed that the upper surface of the cylindrical cast Al—Mg—Sc—Zr alloy ingot includes a higher count density of Al₃(Sc₁₋ₓ, Zrₓ) precipitates than the lower surface, the latter of which was cooled more rapidly. The average size of the Al₃(Sc₁₋ₓZrₓ) precipitates on the upper surface (shown in FIG. 3) was also substantially greater than those found on the lower surface (shown in FIG. 4).
c) Effects of cooling rate on the presence, count density and size of precipitates in 16 mm thick plates of cast Al—Mg—Sc—Zr alloy ingots

16 mm thick plates of cast Al—Mg—Sc—Zr alloy ingots were prepared by solidifying a liquid metal alloy by book mold casting.

To produce a 16 mm thick plate cast Al—Mg—Sc—Zr alloy ingots, the alloy metal precursors were weighted to obtain a desired stoichiometry and mixed. After mixing, the alloy metal precursors were then heated to the liquidus temperature until all of the alloy metal precursors were in their liquid state, to thereby produce a molten alloy. The molten alloy was then poured into a book mold (dimensions about 20 cm×about 15 cm×about 16 mm deep). A cooling rate of about 100° C./s was obtained.

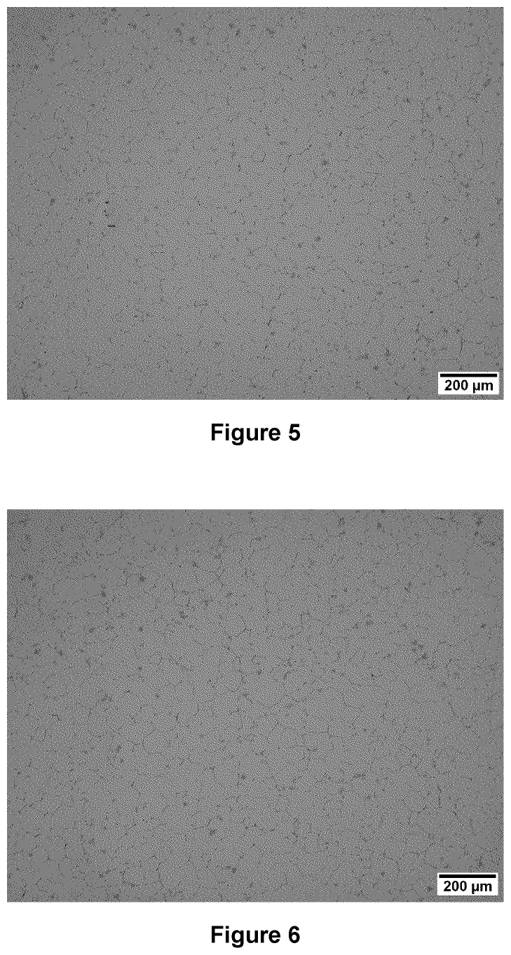

FIG. 5 is an optical micrograph taken at a magnification of 50× and obtained for an upper surface of a 16 mm thick cast Al—Mg—Sc—Zr alloy ingot prepared in Example 1 (c) (scale bar represents 200 μm).

FIG. 6 is an optical micrograph taken at a magnification of 50× and obtained for a lower surface of a 16 mm thick cast Al—Mg—Sc—Zr alloy ingot prepared in Example 1 (c) (scale bar represents 200 μm).

FIGS. 3 and 4 both show a nonuniform dispersion between the Al₃(Sc₁₋ₓZrₓ) precipitates. As can be observed by comparing FIG. 5 and FIG. 6, the upper surface of the 16 mm thick cast Al—Mg—Sc—Zr alloy ingot includes a higher count density of Al₃(Sc₁₋ₓ, Zrₓ) precipitates. In comparison with the cylindrical cast alloy ingot prepared in Examples 1 (a) and (b), the 16 mm thick cast Al—Mg—Sc—Zr based alloy ingot prepared using the method as described in Example 1 (c) appears to have a lower count density of precipitates, an improved dispersity and smaller-sized precipitates.

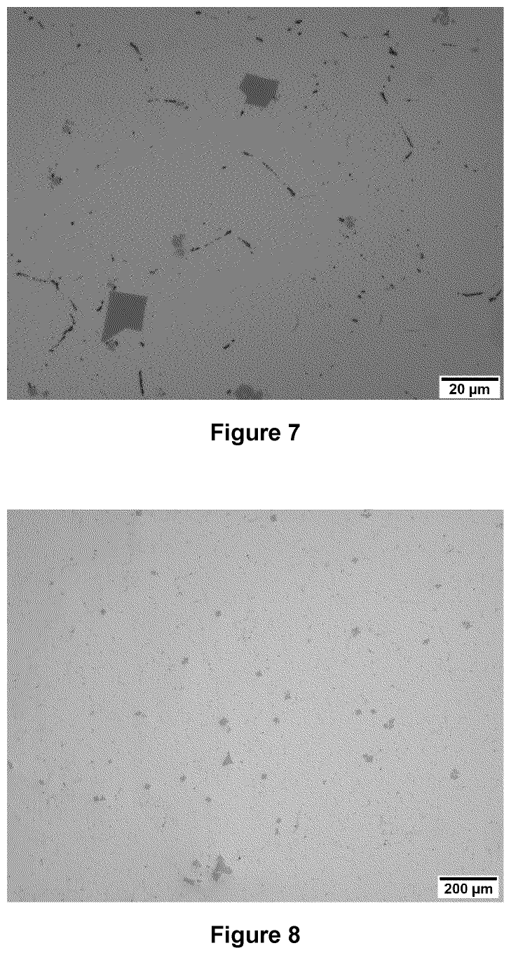

FIG. 7 is an optical micrograph taken at a magnification of 500× showing the microstructure of a surface of a 16 mm thick cast Al—Mg—Sc—Zr alloy ingot prepared in Example 1 (c) (scale bar represents 20 μm). FIG. 7 shows that the larger precipitates have a size of less than 20 μm. For example, in this optical micrograph, the largest precipitate located at the bottom left corner has a width of about 11 μm.
d) Effects of cooling rate on the presence, count density and size of precipitates in 8 mm thick plates of cast Al—Mg—Sc—Zr alloy ingots 8 mm thick plates cast Al—Mg—Sc—Zr alloy ingots were prepared by solidifying a liquid metal alloy by book mold casting.

To produce an 8 mm thick plate Al—Mg—Sc—Zr alloy ingot, the alloy metal precursors were weighted to obtain a desired stoichiometry and mixed. After mixing, the alloy metal precursors were then heated to the liquidus temperature until all of the alloy metal precursors were in their liquid state, to thereby produce a molten alloy. The molten alloy was then poured into a book mold (dimensions about 20 cm×about 15 cm×about 8 mm deep). A cooling rate of about 100° C./s was obtained.

FIG. 8 is an optical micrograph taken at a magnification of 50× and obtained for an upper surface of an 8 mm thick cast Al—Mg—Sc—Zr alloy ingot prepared in Example 1 (d) (scale bar represents 200 μm).

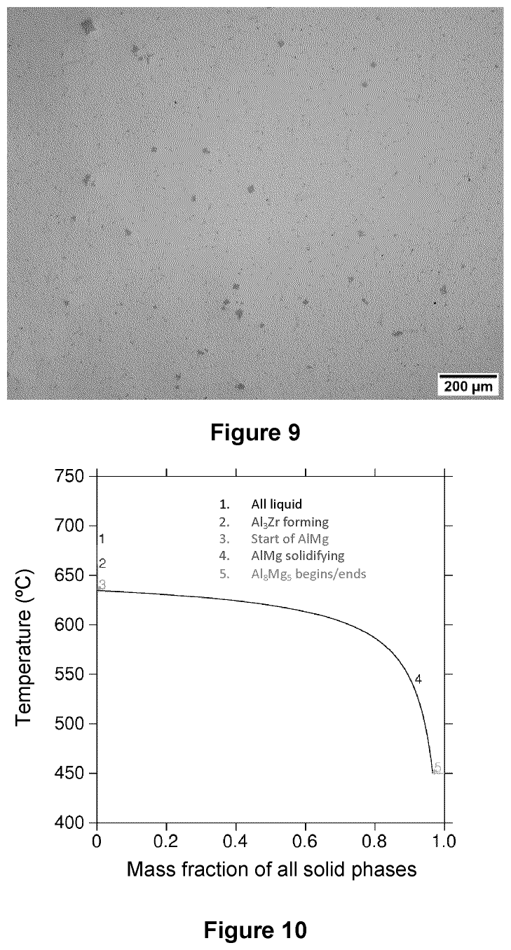

FIG. 9 is an optical micrograph taken at a magnification of 50× and obtained for a lower surface of an 8 mm thick cast Al—Mg—Sc—Zr alloy ingot prepared in Example 1 (d) (scale bar represents 200 μm). FIGS. 8 and 9 both show a nonuniform dispersion between Al₃(Sc₁₋ₓZrₓ) precipitates. As can be seen by comparing FIG. 8 and FIG. 9, the upper surface of the 8 mm thick cast Al—Mg—Sc—Zr alloy ingot includes a higher count density of Al₃(Sc₁₋ₓZrₓ) precipitates.

When comparing this with both the cylindrical cast alloy ingots as prepared in Example 1 (a) and the 16 mm thick cast alloy ingots prepared using the method used in Example 1 (c), the 8 mm thick plates of cast Al—Mg—Sc—Zr alloy ingots as prepared in Example 1 (d) have a lower density count of precipitates, an improved dispersity and smaller-sized precipitates. Therefore, higher cooling rates and a thinner mold lead to a lower count density of precipitates.

### Example 2: Precipitates and Precipitation Behaviors in Cast Al—Mg—Sc—Zr Alloy Ingots

Cast alloy ingots comprising Al—Mg—Sc—Zr were prepared using the process as described in Examples 1 (a), (c) and (d).

8 mm thick alloy ingots with dispersed Al₃(Sc, Zr) precipitates and low precipitate density were obtained using the process described in Example 1 (d). The size of precipitates was significantly smaller (10 μm) than those obtained with the process described in Examples 1 (a) and 1 (c).

Table 1 displays results obtained with the same alloy composition using two different casting processes, different ingot thickness and cooling rate.

| | | Ingot | Count | Precipitate |
|---|---|---|---|---|
| Alloy | Casting | size | density | size |
| Specific | Direct chill | 15 cm | High | 50-200 μm |
| Al- | casting as | diameter | | |
| based | described in | | | |
| alloy | Example 1 (a) | | | |
| | Book molding | 16 mm | Medium | 10-30 μm |
| | as described | thick | | |
| | in Example 1 | | | |
| | (c) | | | |
| | Book molding | | | |
| | as described | 8 mm | Low | ≤10 μm |
| | in Example 1 | thick | | |
| | (d) | | | |

Results obtained using the process as described herein show a reduced count density of precipitates present in the produced cast alloy compared to cast alloy obtained by conventional methods. This may be attributed to the use of a substantially higher cooling rate in the present process. Therefore, a higher cooling rate may lead to a lower density of precipitates.

The cast alloy ingots produced using the present processes are highly suitable for use in applications or subsequent processing including but not limited to, applications or subsequent processing that involve remelting of the cast alloy, as the smaller precipitates (<10 μm or <5 μm) readily dissolve during the remelting step, even at lower temperatures and without stirring.

### Example 3: Effects of the Temperature on Cast Al—Mg—Sc—Zr Based Alloys

The effects of the temperature on the physical state of cast Al—Mg—Sc—Zr alloys were investigated.

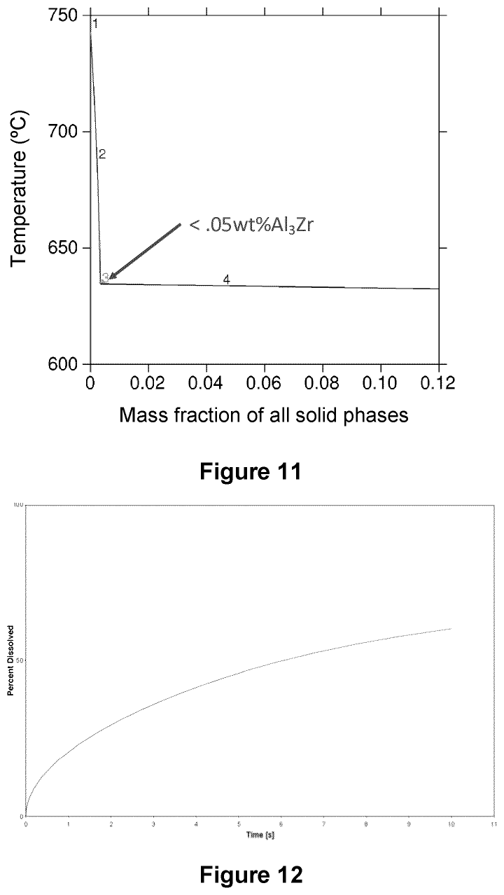

FIG. 10 displays a multi-component phase diagram of an Al—Mg—Sc—Zr quaternary alloy and FIG. 11 presents a zoomed-in section of the portion between 750° C. and 600° C. of the phase diagram as presented in FIG. 10.

FIGS. 10 and 11 show that in the first zone (1) of the graph, all the components of the Al—Mg—Sc—Zr based alloy are in their liquid state. The formation of Al₃Zr may be observed in the second zone (2). FIGS. 10 and 11 effectively show that with 0.24 wt. % of zirconium in the alloy, <0.05 wt. % of Al₃Zr has formed (3^{rd} point on the graph (3)). As can be seen, these Al₃Zr particles start to form at approximately 100° C. before the start of the bulk solidification of the principle α-Al—Mg phase. Further, the Al—Mg—Sc—Zr based alloy must cool for about another 70° C. in order to reach the point at which a degree of coherency of the solidifying Al—Mg matrix would be considered to stop any sedimentation (or flotation) and the growth of the Al₃Zr intermetallics. The reverse phenomenon may occur when melting the cast alloy ingot. For example, this may help dissolving the Al₃Zr precipitates at a substantially low temperature (i.e., without necessarily having to melt the bulk principle α-Al—Mg phase) to reduce the presence of precipitates. It may also help dissolving the Al₃Zr precipitates with a shorter homogenization time at the same substantially low temperature. In FIGS. 10 and 11, the α-Al—Mg phase is represented by the fourth zone (4) and the formation of Al₈Mg₅ occurs in the fifth zone at the right side of the graph (5).

### Example 4: Kinetics of Dissolution Al—Sc Based Alloys

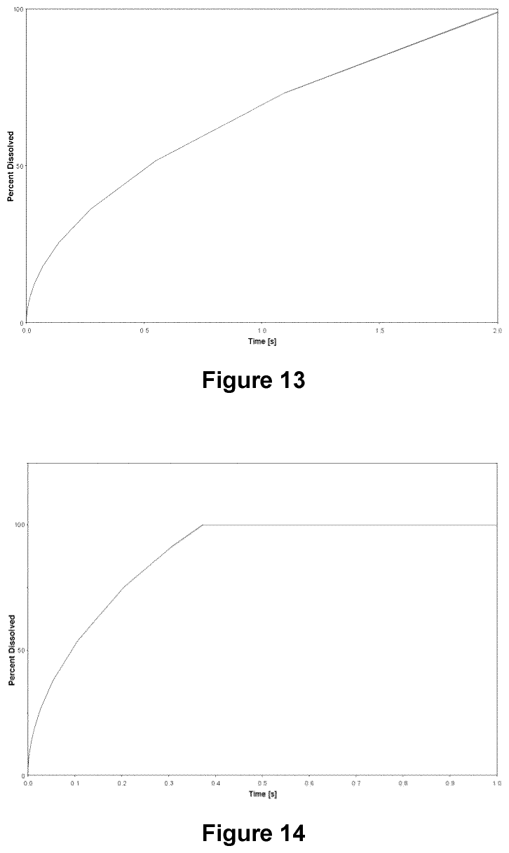

FIGS. 12 to 14 respectively display a precipitation diagram obtained at a temperature of 800° C., 900° C. and 1000° C. for 20 μm diameter Al₃Sc intermetallic precipitates, as described in Example 4. FIGS. 12 to 14 effectively demonstrate the rate at which 20 μm diameter Al₃Sc intermetallic precipitates dissolved at the three different remelting temperatures. The dissolution rate calculation was obtained using Thermo-Calc Software™. The larger precipitates obtained with conventional method would require more time to dissolve.

Numerous modifications can be made to any of the embodiments described above without distancing one from the scope of the present invention. Any references, patents or scientific literature documents referred to in the present patent application are incorporated herein by reference in their entirety for all purposes.

1. A method for producing a metal-based powder that is used in metal additive manufacturing, the method comprising:
melting alloy metal precursors at a temperature above a liquidus temperature thereof until all alloy metal precursors are in liquid state, to produce a molten alloy;
casting the molten alloy by transferring the molten alloy into a caster;
cooling the molten alloy to a temperature of at least below the solidus temperature, at a cooling rate above about 50° C./s, to produce a cast alloy with a low density of precipitates;
remelting the cast alloy with a low density of precipitates to produce a melted alloy; and
forming the metal-based powder from the remelted alloy.

2. The method of claim 1, wherein:
the temperature at which is cooled the molten alloy is at least about 70° C. below the solidus temperature or is of about 50% of the solidus temperature to inhibit a growth rate of precipitates; or
the cooling rate is in the range of from about 50° C./s to about 110° C./s, limits included; or
the remelting is performed at a heating rate of less than about 10° C./s or at a heating rate in the range of from about 0.01° C./s to about 10° C./s, limits included; or
the casting of the molten alloy is performed by direct chill casting, book mold casting or twin-roll casting.

3. (canceled)

4. The method of claim 1, further comprising a homogenization step of the cast alloy with a low density of precipitates to further decrease a density of the precipitates in the cast alloy.

5. The method of claim 4, wherein the homogenization step includes heat treating the cast alloy with a low density of precipitates to a temperature T during a period of time.

6.-11. (canceled)

12. The method of claim 1, wherein forming the metal-based powder from the remelted alloy is performed by atomization.

13. A process for producing a cast alloy with a low density of precipitates tailored to additive manufacturing applications, the process comprising:
melting alloy metal precursors at a temperature above a liquidus temperature thereof until all alloy metal precursors are in liquid state, to produce a molten alloy;
casting the molten alloy by transferring the molten alloy into a caster;
cooling the molten alloy to a temperature of at least below the solidus temperature, at a cooling rate above about 50° C./s, to produce the cast alloy with a low density of precipitates.

14. The process of claim 13, wherein;
the temperature at which is cooled the molten alloy is at least about 70° C. below the solidus temperature or is of about 50% of the solidus temperature to inhibit a growth rate of precipitates; or
the cooling rate is in the range of from about 50° C./s to about 110° C./s, limits included; or
the casting of the molten alloy is performed by direct chill casting, book mold casting or twin-roll casting; or
the process further comprises a homogenization step of the cast alloy with a low density of precipitates to further decrease a density of the precipitates in the cast alloy, preferably wherein the homogenization step includes heat treating the cast alloy with a low density of precipitates to a temperature T during a period of time.

15.-21. (canceled)

22. A process for producing a remelted alloy with homogeneously dispersed precipitates tailored to additive manufacturing applications, the process comprising:
melting alloy metal precursors at a temperature above a liquidus temperature thereof until all alloy metal precursors are in liquid state, to produce a molten alloy;
casting the molten alloy by transferring the molten alloy into a caster;
cooling the molten alloy to a temperature of at least the solidus temperature, at a cooling rate above about 50° C./s, to produce a cast alloy with a low density of precipitates; and
remelting the cast alloy with a low density of precipitates to produce a remelted alloy.

23. The process of claim 22, wherein:
the temperature at which is cooled the molten alloy is at least about 70° C. below the solidus temperature or is of about 50% of the solidus temperature to inhibit a growth rate of precipitates; or
the cooling rate is in the range of from about 50° C./s to about 110° C./s, limits included; or
the remelting is performed at a heating rate of less than about 10° C./s or at a heating rate in the range of from about 0.01° C./s to about 10° C./s, limits included; or
the casting of the molten alloy is performed by direct chill casting, book mold casting or twin-roll casting; or
the process further comprises a homogenization step of the cast alloy with a low density of precipitates to further decrease a density of the precipitates in the cast alloy, preferably wherein the homogenization step includes heat treating the cast alloy with a low density of precipitates to a temperature T during a period of time.

24.-32. (canceled)

33. A cast alloy with a low density of precipitates produced by the process as defined in claims 13 to 21.

34. The cast alloy of claim 33, comprising at least one of aluminum (Al) and magnesium (Mg) and optionally further comprising at least one of scandium (Sc) and zirconium (Zr).

35.-36. (canceled)

37. The cast alloy of claim 33, being a ternary alloy or a quaternary alloy.

38.-39. (canceled)

40. The cast alloy of claim 33, wherein:
the precipitates contained in the cast alloy comprise Al₃(Sc, Zr) of formula Al₃(Sc₁₋ₓZrₓ), where x is 0≤x≤1.0; or
an average size of the precipitates is less than about 50 μm, or is less than about 10 μm, or is less than about 5 μm; or
the precipitates are substantially homogeneously dispersed in the cast alloy

41.-44. (canceled)

45. The cast alloy of 33, wherein:
a chemical composition of the cast alloy is substantially uniform from one radial position to another radial position, and/or from one axial position to another axial position; or
a chemical composition of the cast alloy is uniform from one batch to another.

46. (canceled)

47. A remelted alloy with homogeneously dispersed precipitates produced by the process as defined in claim 22.

48. The remelted alloy of claim 47, comprising at least one of aluminum (Al) and magnesium (Mg) and optionally further comprising at least one of scandium (Sc) and zirconium (Zr).

49.-50. (canceled)

51. The remelted alloy of claim 47, being a ternary alloy or a quaternary alloy.

52.-53. (canceled)

54. The remelted alloy of claim 47, wherein:
a chemical composition of the remelted alloy is substantially uniform from one radial position to another radial position, and/or from one axial position to another axial position; or
a chemical composition of the remelted alloy is uniform from one batch to another.

55. (canceled)

56. Use of the cast alloy as defined in claim 33 in an application that includes a subsequent remelting process.

57. Use of the remelted alloy as defined in claim 47 as a metal alloy feedstock in the production of a metal-based powder tailored for subsequent metal additive manufacturing.
